(19) United States
(12) Patent Application Publication
(10) Pub. No.: US 2014/0023214 A1
(43) Pub. Date: Jan. 23, 2014

(54) METHOD AND APPARATUS FOR AN INPUT DEVICE FOR HEARING AID MODIFICATION

(71) Applicant: Daniel Mark Edgar, Lakeville, MN (US)

(72) Inventor: Daniel Mark Edgar, Lakeville, MN (US)

(73) Assignee: Starkey Laboratories, Inc., Eden Prairie, MN (US)

(21) Appl. No.: 13/551,044

(22) Filed: Jul. 17, 2012

(51) Int. Cl. H04R 25/00

(52) U.S. Cl. 381/314

(57) ABSTRACT

Disclosed herein, among other things, are methods and apparatus for an input device for hearing aid fitting or modification. According to various embodiments, a Microsoft Kinect® or other gesture sensing input device senses a plurality of gestured inputs or speech made remotely from the computer for fitting or modifying a hearing aid. The Microsoft Kinect® or other gesture sensing input device communicates with the fitting system to simplify the fitting process, removing the restriction of mouse and keyboard, and allowing patient participation in the fitting or modification process for a hearing assistance device.

### FIELD OF THE INVENTION

The present subject matter relates generally to hearing assistance devices, and in particular to method and apparatus for an input device for hearing aid fitting or modification.

### BACKGROUND

Hearing assistance devices, such as hearing aids, typically include a signal processor in communication with a microphone and receiver. Such designs are adapted to process sounds received by the microphone. Modern hearing aids are programmable devices that have settings made based on the hearing and needs of an individual patient.

Wearers of hearing aids undergo a process called “fitting” to adjust the hearing aid to their particular hearing and use. In such fitting sessions the wearer may select one setting over another, much like selecting one setting over another in an eye test. Other types of selections include changes in level, which can be a preferred level. A hearing aid fitting system is currently controlled via standard mouse and keyboard input. These input devices center around an audiologist or dispenser having access to a mouse and keyboard while tending to a patient. The standard keyboard and mouse input devices can interfere or preclude patient participation in the fitting process. Furthermore, these sessions require user input, which can be tedious and repetitious. Thus, there is a need in the art for improved communications for performing fitting and modification of hearing assistance devices.

### SUMMARY

Disclosed herein, among other things, are methods and apparatus for an input device for hearing aid fitting or modification. According to various embodiments, a Microsoft Kinect® or other gesture sensing input device aids in a fitting, simplifies the fitting process, removes the restriction of mouse and keyboard, and allows patient participation in the fitting or modification process for a hearing assistance device.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 shows a fitting system using a Microsoft Kinect® input device for sensing according to various embodiments of the present subject matter.

FIG. 2 shows a block diagram of a fitting system using a Microsoft Kinect® input device according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present subject matter relates generally to method and apparatus for fitting a hearing aid using a Microsoft Kinect® or other gesture sensing input device for sensing. A hearing aid fitting system is currently controlled via standard mouse and keyboard input. These input devices center around an audiologist or dispenser having access to a mouse and keyboard while tending to a patient. The standard keyboard and mouse input devices can interfere or preclude patient participation in the fitting process.

The present subject matter relies on the use of fitting system input devices, such as the Microsoft Kinect® input device, to act on gestures and voice recognition that an audiologist or patient can make or say to augment the fitting process. The present subject matter simplifies the fitting process, removes the restriction of mouse and keyboard, and allows patient participation in the fitting process. In addition, patient input into a fitting system is more accessible given a limited range of movement or lack of precision (fine motor control) with keyboard and mouse solutions. Other such devices and interfaces may be used without departing from the scope of the present subject matter. For example, other devices that detect a human gesture in three dimensions (3D) are used in various embodiments, such as skeletal tracking devices, 3D gesture devices, gyroscopic gesture devices, or combinations thereof.

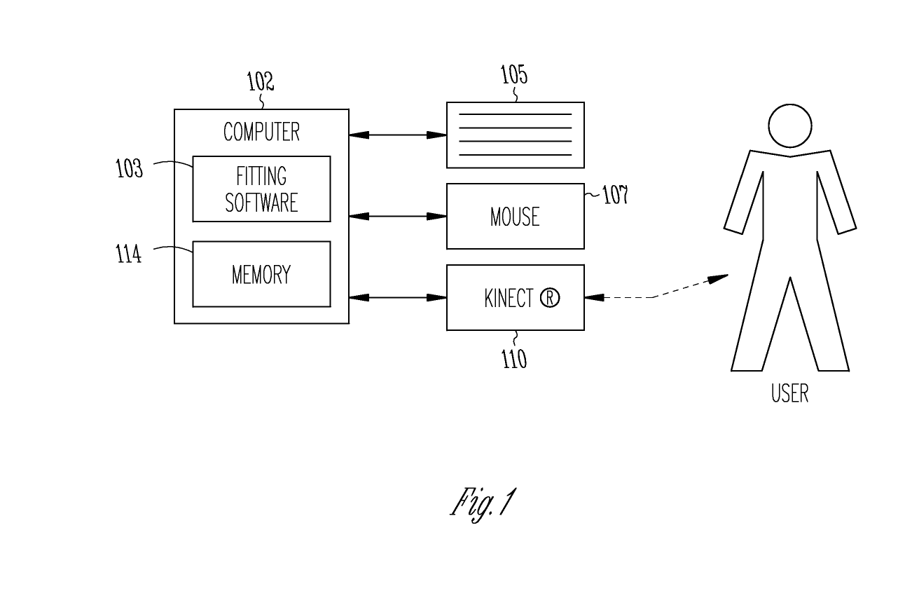

FIG. 1 shows a fitting system using a Microsoft Kinect® or other gesture sensing input device for sensing according to various embodiments of the present subject matter. Computer 102 is adapted to execute fitting software 103 that takes traditional inputs from devices such as keyboard 105 and mouse 107 for fitting one or more hearing aids 120. The system 100 is also adapted to use a Microsoft Kinect® or other gesture sensing input device 110 that is connected to the computer 102. It is understood that the user may be the wearer of one or more hearing aids or can be a clinician, audiologist or other attendant assisting with the use of the fitting system 100. The system 100 includes memory 114 which relates a plurality of inputs with a plurality of operations for the fitting system. It is understood that the configuration shown in FIG. 1 is demonstrative and is not intended in an exhaustive or exclusive sense. Other configurations may exist without departing from the scope of the present subject matter. For example, it is possible that the memory 114 may be encoded in firmware, software, or combinations thereof. It is possible that the system may omit a mouse or a keyboard or may include additional input/output devices without departing from the scope of the present subject matter. Other variations are possible without departing from the present subject matter.

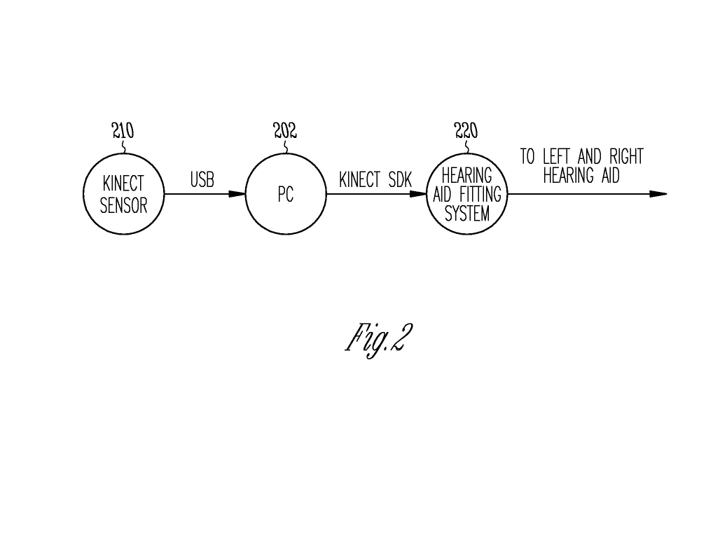

FIG. 2 shows a block diagram of a fitting system using a Microsoft Kinect® or other gesture sensing input device 210 according to various embodiments of the present subject matter. The present subject matter repurposes the Microsoft Kinect® sensor suite as an input tool for patient interaction. The patient does not have to hold anything (such as a remote control) or be “pixel perfect” with a display screen, rather the patient uses in air motions, for example, which are related to a computer 202 and translated into hearing aid response changes using a hearing aid fitting system 220, in various embodiments. In one embodiment, the Kinect® input device 210 is connected to a personal computer 202 using a Universal Serial Bus (USB) connection, such as wireless or wired USB. The computer 202 uses Kinect® software development kit (SDK) to interface to the hearing aid fitting system 220, in various embodiments. The hearing aid fitting system communicates with the left and right hearing aids of a patient, using wired or wireless connections, in various embodiments.

Microsoft Kinect® input device is a sensor bar that is able to track body movements via an IR based map, accept hearing commands, and do facial recognition via an integrated camera. In addition the Kinect® input device can be used for voice recognition, in various embodiments. Kinect® sensors can be used to create a command and control device allowing for patient control of a fitting system user interface, such as a SoundPoint user interface for the Inspire fitting system in an embodiment. The Kinect® sensor has outputs which can be monitored by fitting software via the Kinect® SDK, in various embodiments. The Kinect® sensor can determine the location of a patient's arm, hand, and upper torso in 3D space, and can detect gestures that the patient may make. The patient can be seated or standing for this implementation. In addition, the Kinect® sensor will detect the upper torso of the individual, including placement of hands and arms in an embodiment. The placement of hands and arms can be interpreted as gestures which can then be translated by a fitting system into changes to patient driven changes to a hearing aid response, in various embodiments. In various embodiments, an image analysis technique via an attached standard camera can be used.

The Kinect® input device facilitates a series of physical movements, gestures, and speech that an audiologist or patient can make to assist in a fitting. In various embodiments, the gestures or speech are unique to hearing aid fitting. Such gestures or speech are detected and outcomes in the fitting software are realized depending on the particular gesture used.

In various embodiments, gestures and speech for fitting the hearing aid are augmented with video and audio feedback. In various embodiments, the specific gestures are intuitive extensions of typical responses by individuals. One example is a head gesture up and down for “yes” and side to side for “no.” Other gestures for example, include quick upward head movements or “thumbs up” movements for “more.” A “thumbs down” gesture can be used for less. And an OK sign (thumb to finger in a circle) can be used for a setting that is good for the user.

The fitting software can perform many functions when the gesture or speech triggers. This process has the possibility to eliminate or reduce mouse tracking/seek. It can also avoid non-intuitive keyboard key shortcuts which may not be known to some persons. It can alleviate the need for “expert” learning of a system. It can also limit the amount of icon/graphic use, because gestures can perform major functions of the software.

The use of gestures and speech recognition can also immerse a patient in their own hearing aid fitting. A patient can be exposed to a simulated media environment (i.e. 5.1 Surround Sound), and through the logging of gestures or speech during the simulation the hearing aid can be adjusted according to patient specifications driven from the gestures.

In various embodiments, gestures and/or speech are logged and recorded for playback at a later time, either via video or just the gesture stream.

The following sample gestures and/or speech commands are useful for a Kinect® input device. It is understood that these gestures and commands are provided to demonstrate the invention and are not intended in an exhaustive or exclusive sense: to indicate which ear has a problem; for Best Fit; for Environment Change; for Louder/Softer and different extremes of Louder/Softer; to cycle to next/previous adjustment; to start playing certain kinds of media files; for “Start Over”; and for “Undo last change”. Many other gestures and commands can be derived for what kind of specific adjustment to make. For example, adjustments in band, indicator tone, for signaling when everything is O.K., for signaling when something is not right, for starting a session, for signaling when a session is complete, to start a new process, or for other specialized functions.

Various programming options exist for gaming controls that can be adapted for use with hearing aid fitting. There are direct drivers that relay the values from the sensor device which allow a software developer to detect gestures and give meaning to those gestures via feedback within software applications. Other programming environments exist and are being developed which can be used with the present subject matter.

The present subject matter is demonstrated in the fitting of hearing aids, including but not limited to, behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user. The present subject matter can also be used in hearing assistance devices generally, such as cochlear implant type hearing devices. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method for fitting a hearing aid worn by a wearer with a fitting system, comprising:
programming a three-dimensional gesture sensing input device adapted to input a plurality of gestures or speech by a user of the system during a fitting session and adapted to convert each of the gestures into information useable by the fitting system for the fitting session.

2. The method of claim 1, wherein the three-dimensional gesture sensing input device includes a Microsoft Kinect® input device.

3. The method of claim 1, wherein the information includes settings for the fitting system based on the gestures or speech.

4. The method of claim 1, wherein the information includes settings for the hearing aid based on the gestures or speech.

5. The method of claim 1, further comprising logging the gestures or speech during the fitting session.

6. The method of claim 1, wherein the information indicates starting a fitting session.

7. The method of claim 1, wherein the information includes an indicated ear.

8. The method of claim 1, wherein the information indicates an environment change.

9. The method of claim 8, further comprising cycling a current memory environment to another environment.

10. The method of claim 1, wherein the information indicates a louder or softer volume setting.

11. The method of claim 1, wherein the information indicates playing certain media files.

12. The method of claim 1, wherein the information indicates to start the fitting session over.

13. The method of claim 1, wherein the information indicates that the fitting system should undo its last sensed change.

14. The method of claim 1, further comprising terminating the fitting session based on the information.

15. A system for sensing a plurality of gestured inputs or speech to a fitting system for fitting a hearing aid, the fitting system executing on a computer, the system comprising:
a three-dimensional gesture sensing input device for sensing the plurality of gestured inputs or speech made remotely from the computer to communicate with the fitting system; and
computer readable information stored in memory to associate each of the plurality of gestures or speech with an operation used in fitting the hearing aid,
wherein the computer readable information is accessible by the computer to convert each of the plurality of gestures or speech into an appropriate instruction to operate the fitting system based on each of the plurality of gestures or speech.

16. The system of claim 15, wherein the hearing aid includes a behind-the-ear (BTE) hearing aid.

17. The system of claim 15, wherein the hearing aid includes an in-the-ear (ITE) hearing aid.

18. The system of claim 15, wherein the hearing aid includes an in-the-canal (ITC) hearing aid.

19. The system of claim 15, wherein the hearing aid includes a completely-in-the-canal (CIC) hearing aid.

20. The system of claim 15, wherein the three-dimensional gesture sensing input device includes a Microsoft Kinect® input device.
